(19) United States
(12) Patent Application Publication
(10) Pub. No.: US 2012/0219361 A1
(43) Pub. Date: Aug. 30, 2012

(54) GEOLOGICAL CARBON DIOXIDE STORAGE SYSTEM WITH IMPROVED RELIABILITY

(75) Inventors: Jeong-Chan Kim, Daejeon (KR); Tae-Hee Kim, Daejeon (KR); Ki-Sung Sung, Incheon (KR)

(73) Assignee: Korea Institute of Geoscience and Mineral Resources (KIGAM), Daejeon (KR)

(21) Appl. No.: 13/157,366

(22) Filed: Jun. 10, 2011

(30) Foreign Application Priority Data
Feb. 24, 2011 (KR) KR10-2011-0016542

(51) Int. Cl. B65G 5/00

(52) U.S. Cl. 405/129.5

(57) ABSTRACT

Disclosed is a geological CO₂ storage system that allows geological storage and management of CO₂. A geological CO₂ storage for storing CO₂ stored in a plurality of storage tanks in a predetermined geologic formation, and a CO₂ concentration detector disposed in an unsaturated zone located below a ground surface corresponding to the geologic formation where CO₂ is stored detects a concentration of CO₂ in the unsaturated zone. The geological CO₂ storage includes a manifold section for introducing CO₂, a distribution chamber communicating with the manifold section and an outlet side connected to an injection pipe extending toward the geologic formation so that the CO₂ introduced through the manifold section is supplied to the injection pipe, a temperature regulator for regulating temperature of CO₂ introduced into the distribution chamber, and a flux/pressure regulator for regulating a flux and a pressure of the CO₂ to be geologically injected through the distribution chamber.

### CROSS-REFERENCE TO RELATED APPLICATION

This application claims the benefit under 35 U.S.A. §119 of Korean Patent Application No. 10-2011-0016542, filed on Feb. 24, 2011 in the Korean Intellectual Property Office, the entirety of which is incorporated herein by reference.

### BACKGROUND OF THE INVENTION

1. Field of the invention

The present invention relates to a geological carbon dioxide (CO₂) storage system. More particularly, the present invention relates to a geological carbon dioxide CO₂ storage system that can geologically store CO₂ stably and effectively monitor leakage of CO₂ during or after storage of CO₂.

2. Description of the Related Art

Nowadays, global warming is becoming an international issue and is known to be mainly influenced by CO₂. Much CO₂ is contained in gases exhausted from thermal power plants using coals, steel mills using iron ores as raw materials, and petrochemical plants using petroleum as raw materials. Accordingly, it is necessary to process CO₂ generated by the above factors in order to minimize the global warming.

The CO₂ processing technologies include the geological storage technology, the ocean storage technology, and the mineral carbonation technology.

Among them, the ocean storage technology is for storing CO₂ in the ocean or at the bottom of the sea in a gaseous, liquefied, solidified, or hydrate state. The ocean storage technology has not been tried earnest until now due to concerns about damage to marine ecosystems and instability in long-term CO₂ storage.

The mineral carbonation technology is for chemically reacting CO₂ mainly with metal oxides such as calcium and magnesium to process CO₂ in a non-soluble carbonate mineral state. The mineral carbonation technology requires a large amount of reaction energy and may cause environmental problems in storage and processing of carbonate minerals, making it difficult to realize the technology.

Thus, the geological storage technology is evaluated as the most effective CO₂ processing technology.

The geological CO₂ storage technology is for storing CO₂ in a suitable geologic formation existing 750 to 1000 m beneath the ground (or the bottom of the sea). Since the CO₂ injected beneath the ground exists in a supercritical fluid state, its behavior is very slow and is stuck or dissolved while reacting with a peripheral geologic formation or an underground fluid. For this reason, the geological CO₂ storage technology is also called a geological CO₂ isolating technology.

### SUMMARY

The present invention has been made to solve the problems occurring in the prior art, and an object of the present invention is to provide a geological carbon dioxide CO₂ storage system that can geologically store CO₂ stably and effectively monitor leakage of CO₂ during or after storage of CO₂, thereby improving the reliability of geological storage.

In order to accomplish the above object, the present invention provides a geological CO₂ storage system comprising: geological CO₂ storage for storing CO₂ stored in a plurality of storage tanks in a predetermined geologic formation; and a CO₂ concentration detector disposed in an unsaturated zone located below a ground surface corresponding to the geologic formation where CO₂ is stored, for detecting a concentration of CO₂ in the unsaturated zone.

The geological CO₂ storage includes a manifold section divided into a plurality of branches so that CO₂ for geological storage can be introduced from the storage tanks therethrough, a distribution chamber an inlet side of which is communicated with the manifold section and an outlet side of which is connected to an injection pipe extending toward the geologic formation so that the CO₂ introduced through the manifold section is supplied to the injection pipe, a temperature regulator for regulating a temperature of the CO₂ introduced into the distribution chamber, and a flux/pressure regulator for regulating a flux and a pressure of the CO₂ to be geologically injected through the distribution chamber.

The CO₂ concentration detector includes a gas collection chamber installed in the unsaturated zone and having a tub-like shape, a gas introduction opening formed on a side surface of the gas collection chamber, and a CO₂ concentration sensor formed at an upper portion of the gas collection chamber, for measuring a concentration of the CO₂ contained in the gases within the gas collection chamber.

The geological CO₂ storage system according to the present invention includes a geological CO₂ storage capable of stably controlling a pressure and a temperature of CO₂ injected from CO₂ storage tanks into a geologic formation where CO₂ is stored, and a CO₂ concentration detector capable of effectively monitoring a concentration of CO₂ in an unsaturated zone right below the ground surface.

Therefore, according to the geological CO₂ storage system of the present invention, CO₂ can be geologically stored stably and leakage of CO₂ can be easily monitored during or after geological storage of CO₂.

### BRIEF DESCRIPTION OF THE DRAWINGS

FIG. 1 schematically illustrates a geological CO₂ storage system according to an embodiment of the present invention;

FIG. 2 illustrates an embodiment where the temperature, flux, and fluid pressure of CO₂ which is to be injected into the ground are regulated;

FIG. 3 schematically illustrates an unsaturated zone CO₂ concentration detector provided in a site where CO₂ is geologically stored according to the present invention;

FIG. 4 schematically illustrates an unsaturated zone CO₂ concentration monitoring system in a site where CO₂ is geologically stored according to the present invention;

FIG. 5 schematically illustrates a monitoring server of FIG. 4; and

FIG. 6 is a flowchart illustrating a method of monitoring an unsaturated zone CO₂ concentration in a site where CO₂ is geologically stored according to the present invention.

### DETAILED DESCRIPTION OF THE EMBODIMENTS

The above and other aspects, features and advantages of the present invention will be more apparent from the following detailed description taken in conjunction with the accompanying drawings. However, the present invention is not limited to the below-described embodiments but may be realized in various forms. The embodiments of the present invention only aim to fully disclose the present invention and inform those skilled in the art of the scope of the present invention. Thus, the present invention is defined only by the scopes of the claims. The same or like reference numerals refer to the same or like elements throughout the specification.

Hereinafter, a geological CO₂ storage system with an improved reliability according to an embodiment of the present invention will be described in detail with reference to the accompanying drawings.

FIG. 1 schematically illustrates a geological CO₂ storage system according to an embodiment of the present invention.

Referring to FIG. 1, the geological CO₂ storage system according to the embodiment of the present invention includes a geological CO₂ storage 110 to 140 and at least one CO₂ concentration detector 300.

The geological CO₂ storage 110 to 140 makes it possible to store CO₂ stored in a plurality of storage tanks in a predetermined geologic formation.

The CO₂ concentration detector 300 is disposed in an unsaturated zone located under the ground and corresponding to the geologic formation where CO₂ is stored, and detects a concentration of CO₂ kept in the unsaturated zone.

Geological CO₂ Storage

First, the geological CO₂ storage will be described.

Referring to FIG. 1, the geological CO₂ storage includes a manifold section 110, a distribution chamber 120, a temperature regulator 130, and a flux/pressure regulator 140.

A plurality of pipes are branched in the manifold section 110 so that CO₂ can be supplied through the pipes so as to be injected into the ground.

The manifold section 110 includes pipes for feeding CO₂ kept in individual storage tanks T into the distribution chamber 120 in an integrated fashion.

To achieve this, the manifold section 110 preferably has manifolds disposed in a plurality of rows to avoid interference. In this case, the number of pipes disposed in rows is preferably designed to correspond to the number of the storage tanks T, but the present invention is not limited to the illustrated three pipes.

That is, pipes 114 are connected respectively to outlets of the storage tanks T for storing CO₂ in individual places, so that the CO₂ can be effectively fed through the pipes 114. The manifold section 110 serves to join the CO₂ fed and distributed through the pipes 114 into the distribution chamber 120.

Then, the manifold section 110 preferably further includes sockets 112 expanding at portions of the pipes 114 so that the pipes 114 can be conveniently coupled to the storage tanks T.

The storage tanks T are storage vessels for keeping CO₂ provisionally and temporarily. The storage tanks T are preferably pressure tanks where CO₂ whose amount is large in comparison to their limited internal volumes can be easily kept.

Preferably, electric thermostats 119 are installed at lower sides of the storage tanks T to maintain the temperature of the CO₂ kept in the storage tanks T at an optimal level. A detailed example of such an electric thermostat 119 may include an induction heating coil configured to emit heat using electric power Vs from the outside.

A stop valve 116 and a pressure gauge 118 may be further installed at an outlet side of each storage tank T. The stop valve 116 is adapted to regulate flow of an internal fluid in an opening/closing fashion to switch on and off the flow of the fluid. Such a stop valve 116 opens and closes the flow of the CO₂ flowing from the storage tanks T toward the distribution chamber 120. The pressure gauge 118 detects a pressure of the CO₂ which is supplied from the storage tanks T into the distribution chamber 120.

The temperature and pressure of the CO₂ supplied from the storage tanks T may be set to 50 degrees Celsius and 40 bars, but may be arbitrarily selected depending on a CO₂ storage condition/environment.

The CO₂ kept in the storage tanks T moves along the different pipes 114 and joins in the distribution chamber 120 via the manifold section 112.

The distribution chamber 120 makes it possible to supply the CO₂ supplied through the manifold section 110 into the geologic formation through an injection pipe 122 connected to a predetermined geologic formation.

In this case, the injection pipe 122 is connected to the geologic formation along a preformed exploratory hole 201. A packer may be installed within the exploratory hole 201 to position and fix the injection pipe, and CO₂ can be stably stored in a geologic formation through the exploratory hole 201 and the packer 203.

An inlet 120a of the distribution chamber 120 is communicated with an outlet opening of the manifold section 110, and an outlet 120b of the distribution chamber 120 is connected to the injection pipe 122 extending toward the predetermined geologic formation for storage of CO₂. To achieve this, the distribution chamber 120 functions to help supply the CO₂ introduced through the manifold section 110 into the geologic formation through the injection pipe 122.

That is, the distribution chamber 120 incorporates the CO₂ introduced from the storage tanks T through the manifold section 110 and helps inject the CO₂ into the geologic formation through the injection pipe 122 on the outlet side.

For more stable incorporation and distribution of CO₂, the distribution chamber 120 may be enclosed by a casing 124 in the form of a pressure vessel, and a heater 133 of the temperature regulator 130, which will be described below, may be installed around an outer periphery of the distribution chamber 120.

The heater 133 may heat the CO₂ in the distribution chamber 120 to increase a temperature of the CO₂ to a value set by the user.

The temperature regulator 130 regulates a temperature of the CO₂ introduced into the distribution chamber 120.

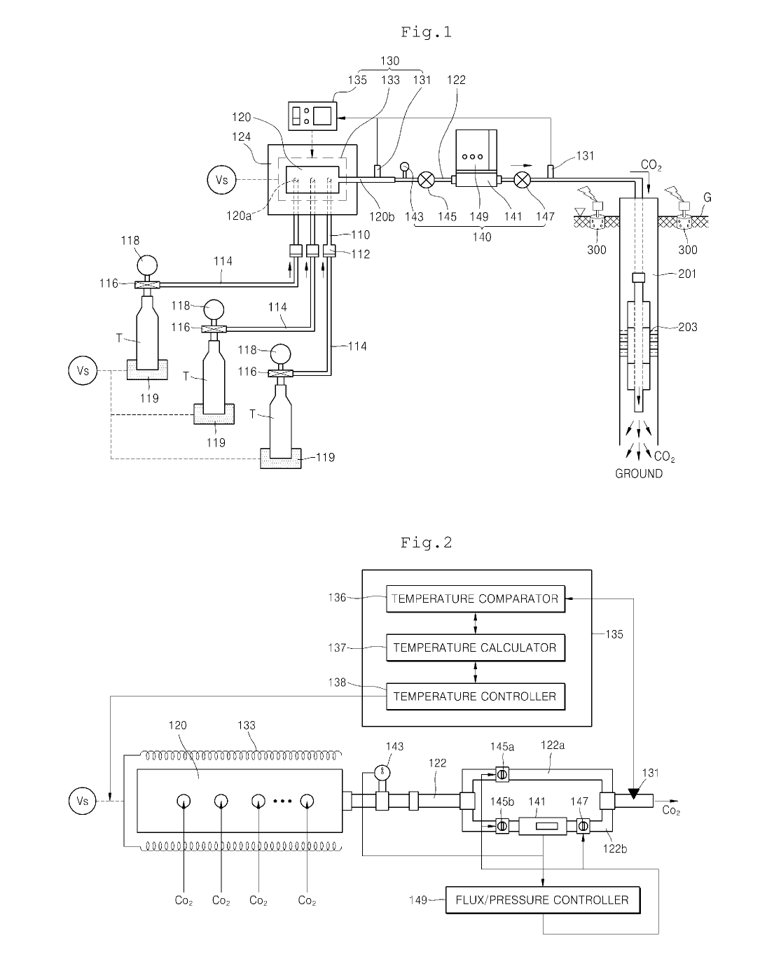

To achieve this, the temperature regulator 130 may include a temperature sensor 131 configured to detect a temperature of the CO₂ to be injected into the ground, a heater 133 configured to heat the CO₂ introduced into the distribution chamber 120 to increase a temperature of the CO₂, and a controller (135 of FIG. 2) configured to compare a temperature of the CO₂ detected by the temperature sensor 131 with a preset value, calculate a temperature compensation value of CO₂ whose temperature is to be increased, and control an operation of the heater 133.

Then, the configuration of the controller (135 of FIG. 2) will be described in detail during a description of FIG. 2, and the configurations of the temperature sensor 131 and the heater 133 will only be described here.

The temperature sensor 131 may be mounted onto the injection pipe 122, and is a type of sensing means configured to measure an actual temperature of the CO₂ supplied to the geologic formation through the injection pipe 122. Such a temperature sensor 131 may be any type of thermometer.

The heater 133 serves to heat the CO₂ introduced into the distribution chamber 1230 within a certain range of increased temperature. The temperature of the CO₂ may be determined to be approximately 50 degrees Celsius by the heater 133, but may be varied by a CO₂ storage environment.

A detailed example of such a heater 130 may be an induction heater configured to generate resistance heat using external power Vs and increase a temperature of the CO₂ in the distribution chamber 120.

The flux/pressure regulator 140 regulates a flux and a pressure of the CO₂ to be injected into the ground through the distribution chamber 120. Such a flux/pressure regulator 140 serves to regulate a flux and a pressure of the CO₂ injected into the ground through the distribution chamber 120.

As illustrated, the flux/pressure regulator 140 may include a flux detector 141 configured to detect a flux of the CO₂ to be injected into the ground through the distribution chamber 120, a pressure detector 143 configured to detect a pressure of the CO₂ to be injected into the ground through the distribution chamber 120, and valves 145 and 147 configured to switch on and off the flow of the CO₂ to be injected into the ground through the distribution chamber 120 to regulate a flux of the CO₂ and regulate a flow pressure of the CO₂.

In this case, both the flux detector 141 and the pressure detector 143 are installed on the injection pipe 122 to effectively detect a flux and a pressure of the CO₂ discharged through the distribution chamber 120. The flux detector 141 and the pressure detector 143 maybe a commercial flowmeter and a commercial pressure gauge.

As illustrated in FIG. 1, the valves 145 and 147 may be installed on the front and rear sides of the flux detector 141. As illustrated in FIG. 2, the valves 145a, 145b, and 147 may be installed on pipes branched out in the form of a dual pipe in a section of the injection pipe 122.

The flux/pressure regulator 140 may further include a flux/pressure controller 149 in addition to the flux detector 141, the pressure detector 143, and the valves 145 and 147.

The function and role of the flux/pressure controller 149 can be confirmed in detail in FIG. 2.

That is, the flux/pressure controller 149 illustrated in FIG. 2 compares a flux and a pressure of the CO₂ detected by the flux detector 141 and the pressure detector 143 with preset reference values and controls an opening/closing operation of the valves 145a, 145b, and 147 so that the CO₂ to be injected into the ground can be supplied at an optimal pressure and at an optimal flux.

The flux/pressure controller 149 allows positive control of the flux detector 141 and the pressure detector 143, and the valves 145a, 145b, and 147 opened and closed in conjunction with the flux detector 141 and the pressure detector 143, making it possible to distribute CO₂ in a prompt and accurate condition.

FIG. 2 illustrates an embodiment of the present invention where a temperature, a flux, and a pressure of the CO₂ to be injected into the ground are regulated.

Referring to FIG. 2, the temperature regulator 130 includes a controller 135.

The controller 135 includes a temperature comparator configured to compare a temperature of the CO₂ detected by the temperature sensor 131 with a preset reference value, a temperature calculator 137 configured to calculate a temperature compensation value of the CO₂ to be increased by the heater 133 through the comparison, and a temperature adjustor 138 configured to control an operation of the heater 133 to increase a temperature of the CO₂ in the distribution chamber 120 by the calculated temperature compensation value.

In this case, “a preset reference value” refers to a target temperature value of the CO₂ to be injected into the ground by the user in the description of the function of the temperature comparator 136, and when a temperature of the CO₂ detected by the temperature sensor 131 is lower than “the preset reference value”, a temperature compensation value corresponding to the difference is increased by controlling an operation of the heater 133.

As described above, as illustrated in FIG. 1, the CO₂ stored in the storage tanks may be stored in a geologic formation after a temperature, a flux, and a pressure of the CO₂ is regulated by the geological CO₂ storage including the manifold section, the distribution chamber, the temperature regulator, and the flux/pressure regulator.

CO₂ Concentration Detector

Next, the CO₂ concentration detector will be described.

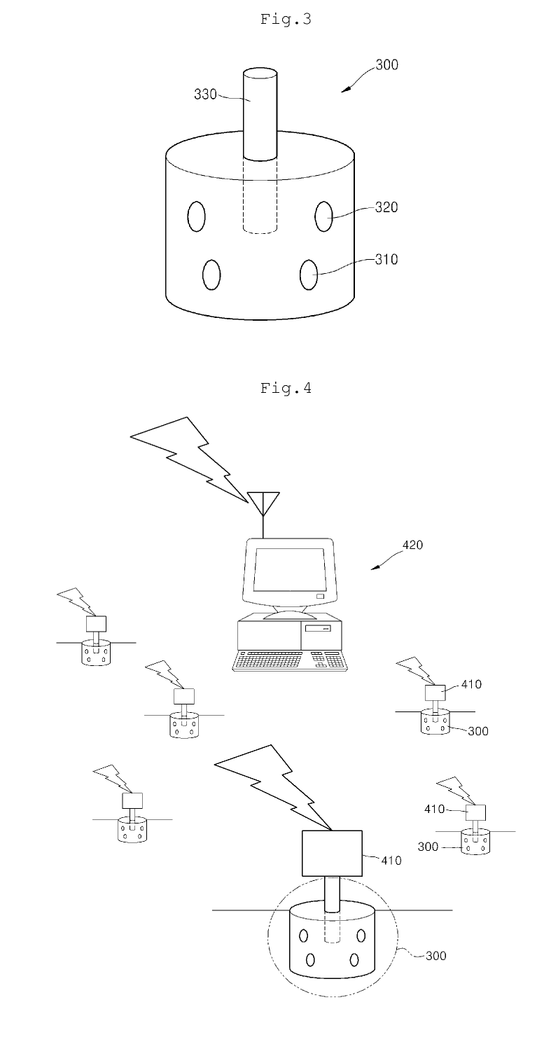

FIG. 3 schematically illustrates a CO₂ concentration detector according to the present invention.

Referring to FIG. 3, the CO₂ concentration detector 30 includes a gas collection chamber 310, a gas introduction opening 320, and a CO₂ concentration sensor 330.

The gas collection chamber 310 has a tub-like shape such as a cylindrical tub and a rectangular tub, and is buried in an unsaturated zone beneath the ground surface. In this case, an unsaturated zone refers to a layer above a ground water layer, where non-cemented rocks and soil are distributed and soil gases (oxygen, nitrogen, CO₂, etc.) and moisture exist. The unsaturated zone is located approximately 50 to 300 cm below the ground surface.

The material of the gas collection chamber 310 is preferably a material that can be used for a long time without disturbing the soil layer, cannot easily react with gases, and cannot absorb gases. The material of the gas collection chamber 310 satisfying such conditions may be stainless steel. A plurality of water discharge hole may be formed at the bottom of the gas collection chamber 310 so that water can be naturally discharged due to gravity when underground water or soil water is introduced into the gas collection chamber 310.

The gas introduction opening 320 is formed on a side surface of the gas collection chamber 310 to allow the gas outside the gas collection chamber 310 to be introduced into the gas collection chamber 310. The gas introduction opening 320 may have a mesh-like form, i.e. a net-like form.

Meanwhile, a plurality of gas introduction openings 320 may be formed on a side surface of the gas collection chamber 310.

The CO₂ concentration sensor 330 is formed at an upper portion of the gas collection chamber 310 to penetrate the gas collection chamber 310, and measures a concentration of the CO₂ contained in the gases within the gas collection chamber 310.

A variety of sensors may be used as the CO₂ concentration sensor 330, but an NDIR (non-dispersive infra-red) sensor which is convenient to use and excellent in measurement accuracy is preferably used.

Meanwhile, when the NDIR sensor is installed in soil, its measurement may be incomplete if the amounts of gases in soil porosities are non-uniform. Thus, it is preferable that gases whose amounts are more than predetermined values are collected in the gas collection chamber 310 installed in the soil layer and a concentration of CO₂ contained in the gases which is connected in the gas collection chamber 310 and whose distribution is standardized is measured using the NDIR sensor.

The CO₂ concentration detector 300 according to the present invention may further include an alkaline earth metal hydroxide introduction/storage section (not shown) where an alkaline earth metal hydroxide is supplied into the gas collection chamber 310 to be stored so that it may react with CO₂ in the gas collection chamber 310 as in Chemical Formula 1 to convert the CO₂ to a carbonate mineral. Then, the alkaline earth metal hydroxide may be Mg(OH)₂, Ca(OH)₂, and Ba(OH)₂.

M(OH)₂+CO₂→MCO₃+H₂O Chemical Formula 1

where M is an alkaline earth metal.

The alkaline earth metal hydroxide supplied into and stored in the gas collection chamber 310 reacts with CO₂ and forms a carbonate mineral. In particular, as it is known that the amount of CO₂ in soil is approximately 300 times as large as the amount of CO₂ in the atmosphere, the amount of CO₂ in soil is sufficient enough to create the reaction. The introduction of alkaline earth metal in the alkaline earth meal hydroxide introduction/storage section may be implemented through a side surface of the gas collection chamber 310, but may also be implemented in a separate space in the gas collection chamber 310.

The alkaline earth metal is stored only in the alkaline earth metal hydroxide introduction/storage section and is isolated from the interior space of the gas collection chamber 310 by the time when a concentration of CO₂ starts to be detected. It is because if an alkaline earth metal hydroxide exists in the gas collection chamber 310 when a concentration of CO₂ is detected, the accuracy in detection of a concentration of CO₂ may worsen.

Thus, it is preferable that an alkaline earth metal hydroxide may communicate with the gases in the interior space of the gas collection chamber 310 at a time when CO₂ is not detected. For example, if a CO₂ concentration detection cycle is one hour, the alkaline earth metal hydroxide introduction/storage section may be communicated with the interior of the chamber for 30 minutes shortly after the concentration of CO₂ is detected.

Due to the alkaline earth metal hydroxide introduction/storage section, a carbonate mineral can be created and the amount of CO₂ can be reduced while a concentration of CO₂ is detected.

Since the CO₂ once leaked above the ground surface is rapidly mixed with the atmosphere and dispersed, it is difficult to detect a concentration of the dispersed CO₂ and determine an operation of ground injection equipment. Thus, if a concentration of CO₂ becomes abnormally high in an unsaturated zone before the CO₂ is leaked, the operation of the ground injection equipment for geological CO₂ storage is temporarily stopped and it is necessary to check a concentration and leakage of the CO₂ to determine whether CO₂ is to be continuously injected.

FIG. 4 schematically illustrates an unsaturated zone CO₂ concentration monitoring system at a site where CO₂ is geologically stored according to the present invention.

Referring to FIG. 4, the unsaturated zone CO₂ concentration monitoring system includes a plurality of unsaturated zone CO₂ concentration detectors 300, a plurality of communication units, and a monitoring server 420.

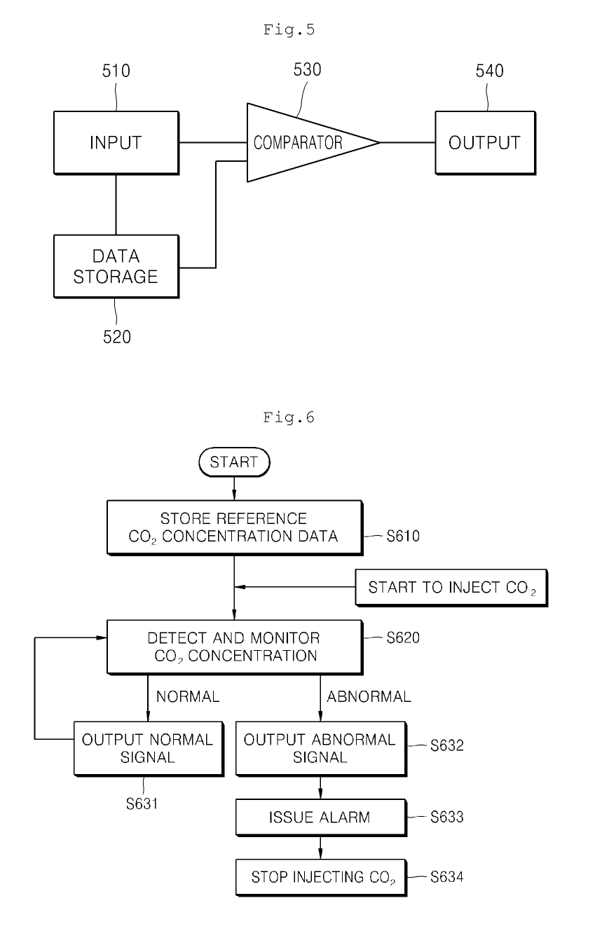

A chamber, a gas introduction opening, and a CO₂ concentration sensor of each unsaturated zone CO₂ concentration detector 300 are the same as those as in FIG. 5, and a detailed description thereof will be omitted.

Meanwhile, a temporary CO₂ storage facility such as a storage tank, a CO₂ pressuring facility, a heating facility, and a CO₂ injection facility are disposed at a CO₂ storing site on the ground corresponding to a geologic formation where CO₂ is stored. Considering existence of the facilities, the CO₂ storing site may have an area of several hundred meters by several hundred meters, but may also have an area of more than 1 km by 1 km.

Thus, a plurality of unsaturated zone CO₂ concentration detectors 300 are disposed at the CO₂ storing site. Since CO₂ can be leaked to the periphery of the CO₂ storing site, a plurality of unsaturated zone CO₂ concentration detectors 300 also are preferably disposed at the peripheral sites as well as the CO₂ storing site.

The communication units 410 are connected to the CO₂ concentration sensors of the unsaturated CO₂ concentration detectors 300 respectively to transmit the CO₂ concentrations output from the CO₂ concentration sensors to the monitoring server 420 through wireless communications. Although wireless communication units are exemplified as the CO₂ concentration transmitting means in the present invention, it is because they are convenient in case of a plurality of unsaturated zone CO₂ concentration detectors 300 and the present invention does not exclude wired communication units.

The monitoring server 420 stores reference CO₂ concentrations for a time interval. The monitoring server 420 compares the measured CO₂ concentrations (C_detec) transmitted from the communication units 410 with the stored reference CO₂ concentrations C_ref for the time interval, and outputs normal signals or abnormal signals through a monitor or a printer. It is apparent that the monitoring server 420 can directly output the measured CO₂ concentrations and can store them in a storage space.

The monitoring server 420 can generate the abnormal signals if the measured CO₂ concentrations C_detec are higher than the reference CO₂ concentrations C_ref after comparing the measured CO₂ concentrations C_detec transmitted from the communication units 410 with the reference CO₂ concentrations C_ref corresponding to the measuring times.

Then, a reference for generating an abnormal signal in the monitoring server 420 may be the case where the measured CO₂ concentration C_detec is higher than the reference CO₂ concentration C_ref by more than a specific value α (C_detec≧C_ref+α).

Also, a reference for generating an abnormal signal in the monitoring server 420 may be the case where the measured CO₂ concentration C_detec is higher than the reference CO₂ concentration C_ref by more than a specific ratio β (C_detec≧β×C_ref+α).

In order to perform the above-described operation, as illustrated in FIG. 5, the monitoring server 420 may include an input 510, a data storage 520, a comparator 530, and an output 540.

The input 510 receives measured CO₂ concentrations C_detec from the communication units 410. The data storage 520 stores reference CO₂ concentration for a time interval.

The comparator 530 receives the measured CO₂ concentrations C_dec from the input 510, receives the reference CO₂ concentrations C_ref from the data storage 520, and outputs ‘0’ and ‘1’ or ‘LOW’ and ‘HIGH’ after comparing the input measured CO₂ concentrations C_detec with the reference CO₂ concentrations C_ref.

The output 540 outputs an abnormal signal or an abnormal signal depending on the result signal of the comparator 530 through an output unit such as a monitor or a printer.

Meanwhile, the monitoring server 420 may be connected to an alarming unit (not shown), which generates an alarming sound such as an alarm or a siren in response to an abnormal signal of the monitoring server 420 to allow a manager or an operator to recognize leakage of CO₂ easily.

FIG. 6 is a flowchart illustrating a method of monitoring a concentration of CO₂ in an unsaturated zone at a site where CO₂ is geologically stored according to an embodiment of the present invention.

Referring to FIG. 6, the method of monitoring a concentration of CO₂ in an unsaturated zone includes a step S610 of storing reference CO₂ concentration data, a step S620 of detecting and monitoring a concentration of CO₂, and a step of outputting a result signal.

In the step S610 of storing reference CO₂ concentration data, the CO₂ concentration detector measures concentrations of CO₂ in an unsaturated zone at a site where CO₂ is geologically stored for a time interval, transmits the measured CO₂ concentrations to the monitoring server through the communication units, and stores the concentrations of CO₂ in an unsaturated zone transmitted from the monitoring server as reference CO₂ concentrations.

The reason why the reference CO₂ concentrations are stored in the monitoring server in advance is as follows.

The concentration of the CO₂ in soil or in an unsaturated zone is changed according to the biological activities in soil and the physical and chemical phenomena influenced by them. That is, it is known that the composition ratio of CO₂ in soil is approximately 300 times higher than the composition of CO₂ in the atmosphere due to decomposition and oxidation of organic compounds. Also, the concentration of CO₂ in soil is changed frequently according to the season, according to day and night, and according to other physical and chemical conditions. It is very difficult to generalize the concentrations of CO₂ in soil because they are different locally according to the characteristics of soil, the depth of a soil layer, and the amounts of moisture in soil are different even between several meters.

Thus, it is necessary to measure the concentrations of CO₂ at a spot for at least one year to recognize the natural background concentration and take a measure when an abnormal value deviating from the background concentration is observed, in order to check leakage of CO₂ injected into the geologic formation.

That is, it is desirable to take a measure against natural and other changes after making sufficient studies on the characteristics of concentrations of CO₂ and factors causing a change in concentration of CO₂ for days, months, quarters, and seasons.

Next, in the step S620 of detecting and monitoring a concentration of CO₂, the CO₂ concentration detector measures concentrations of CO₂ in an unsaturated zone to transmit them to the monitoring server through the communication units after geological storage of CO₂ begins or is completed, the monitoring server compares the measured CO₂ concentrations with the reference CO₂ concentrations.

In the step S631 and S632 of outputting a result signal, the monitoring server outputs a normal signal or an abnormal signal using the result obtained by comparing the measured CO₂ concentrations and the reference CO₂ concentrations. The monitoring server can compare the measured CO₂ concentrations with the reference CO₂ concentrations and generate an abnormal signal if the measured CO₂ concentrations are higher than the reference CO₂ concentrations by more than a predetermined value.

When the monitoring server outputs an abnormal signal, an additional step S633 of outputting an alarm can allow CO₂ to cease to be injected.

As described above, the geological CO₂ storage system according to the present invention can optimally control the pressure and temperature of CO₂ injected into a geologic formation to stably store CO₂ and easily and accurately monitor leakage of CO₂ near the ground surface.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A geological CO₂ storage system comprising:
a geological CO₂ storage for storing CO₂ stored in a plurality of storage tanks in a predetermined geologic formation; and
a CO₂ concentration detector disposed in an unsaturated zone located below a ground surface corresponding to the geologic formation where CO₂ is stored, for detecting a concentration of CO₂ in the unsaturated zone,
wherein the geological CO₂ storage includes a manifold section divided into a plurality of branches such that CO₂ for geological storage is introduced from the storage tanks therethrough, a distribution chamber an inlet side of which is communicated with the manifold section and an outlet side of which is connected to an injection pipe extending toward the geologic formation so that the CO₂ introduced through the manifold section is supplied to the injection pipe, a temperature regulator for regulating a temperature of the CO₂ introduced into the distribution chamber, and a flux/pressure regulator for regulating a flux and a pressure of the CO₂ to be geologically injected through the distribution chamber, and
wherein the CO₂ concentration detector includes a gas collection chamber installed in the unsaturated zone and having a tub-like shape, a gas introduction opening formed on a side surface of the gas collection chamber, and a CO₂ concentration sensor formed at an upper portion of the gas collection chamber, for measuring a concentration of the CO₂ contained in the gases within the gas collection chamber.

2. The geological CO₂ storage system of claim 1, wherein the temperature regulator includes a temperature sensor mounted on the injection pipe for detecting a temperature of the CO₂ discharged from the distribution chamber so as to be geologically injected, and a heater disposed to surround an outer periphery of the distribution chamber for heating the CO₂ introduced into the distribution chamber to rise a temperature of the CO₂.

3. The geological CO₂ storage system of claim 1, wherein the flux/pressure regulator includes a flux detector mounted on the injection pipe for detecting a flux of the CO₂ to be geologically injected, a pressure detector mounted on the injection pipe to detect a pressure of the CO₂ to be geologically injected, and a valve mounted on the injection pipe to regulate a flux and a pressure of the CO₂ discharged from the distribution chamber so as to be geologically injected.

4. The geological CO₂ storage system of claim 1, wherein sockets expanded to be connected to the storage tanks through pipes are further formed at one side of the manifold section.

5. The geological CO₂ storage system of claim 1, wherein electric thermostats for heating the CO₂ stored in the storage tanks to maintain the CO₂ at a constant temperature are further installed at lower sides of the storage tanks.

6. The geological CO₂ storage system of claim 1, wherein a stop valve for switch on or off flow of the CO₂ to be supplied into the distribution chamber and a pressure gauge for detecting a pressure of the CO₂ to be supplied into the distribution chamber are further installed at an outlet side of each of the storage tanks.

7. The geological CO₂ storage system of claim 1, further comprising an alkaline earth metal hydroxide introduction/storage section formed on a side surface of the gas collection chamber, wherein an alkaline earth metal hydroxide supplied through the gas collection chamber is stored in the alkaline earth metal hydroxide introduction/storage section.
